(19) United States
(12) Patent Application Publication
(10) Pub. No.: US 2026/0009319 A1
(43) Pub. Date: Jan. 8, 2026

(54) MACHINE LEARNING CLASSIFICATION OF DAILY BOREHOLE OPERATION REPORTS

(71) Applicant: Halliburton Energy Services, Inc., Houston, TX (US)

(72) Inventors: Fahad Ahmad, Houston, TX (US); Hooi Min Ooi, Houston, TX (US); Olivier Roger Germain, Houston, TX (US)

(21) Appl. No.: 18/763,879

(22) Filed: Jul. 3, 2024

(51) Int. Cl. E21B 44/00; G06F 40/226

(52) U.S. Cl. CPC E21B 44/00; G06F 40/226; E21B 2200/20

(57) ABSTRACT

Daily reports from borehole or reservoir operations can be in various languages, use various sets of activity codes, be missing activity codes, or specify incorrect activity codes. By training a natural language model on a human language and then training the model on borehole and reservoir specific operations, activities, events, and occurrences, the original daily report can be transformed into a standardized daily report. The standardized daily report can use a standard set of activity codes from the client, operator, reference, industry standards, or a combination thereof. This can reduce the time to process a received daily report from days or weeks to a few minutes of processing time. Decision makers can then use the standardized daily report to make faster and more accurate decisions regarding the operations at the borehole or reservoir, such ordering replacement parts sooner or modifying a borehole operation plan.

### TECHNICAL FIELD

This application is directed, in general, to daily borehole operation reports and, more specifically, to classifying activities stated within the daily borehole operation reports.

### BACKGROUND

For operations at a borehole, the engineers and operations personnel generate reports on activities and progress made on the operations scheduled for that day. Borehole operations can be any activity at a borehole, such as drilling, hydraulic fracturing, pumping, measuring, sensing, pressure releasing, or other activities. Since borehole operations occur around the globe, using a variety of companies, and the personnel involved can be comfortable in various languages, the daily reports that are provided can take many forms. The language used may not be a common language, such as English. The report form could be structured with fill-in-the-blanks or free-form fields. Each operator or company can use a different set of codes to track the borehole activities. Codes are not standard across the industry. It would be beneficial to be able to automatically process the daily reports regardless of these differences.

### BRIEF DESCRIPTION

Reference is now made to the following descriptions taken in conjunction with the accompanying drawings, in which:

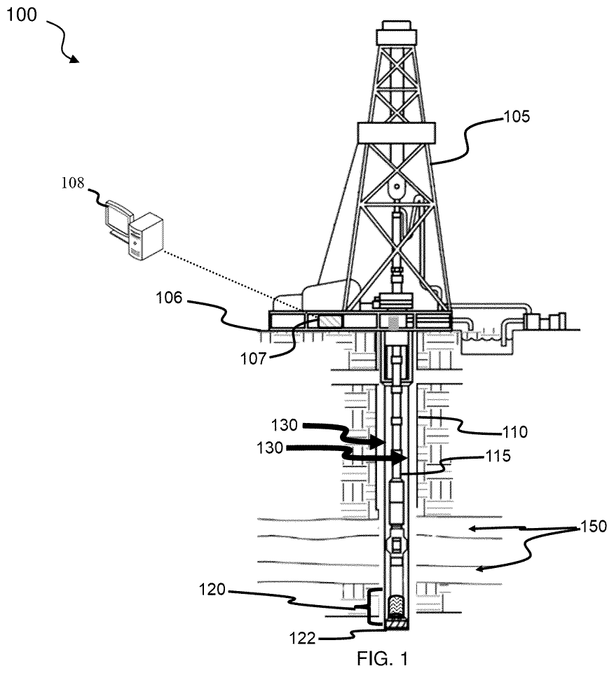

FIG. 1 is an illustration of a diagram of an example drilling system;

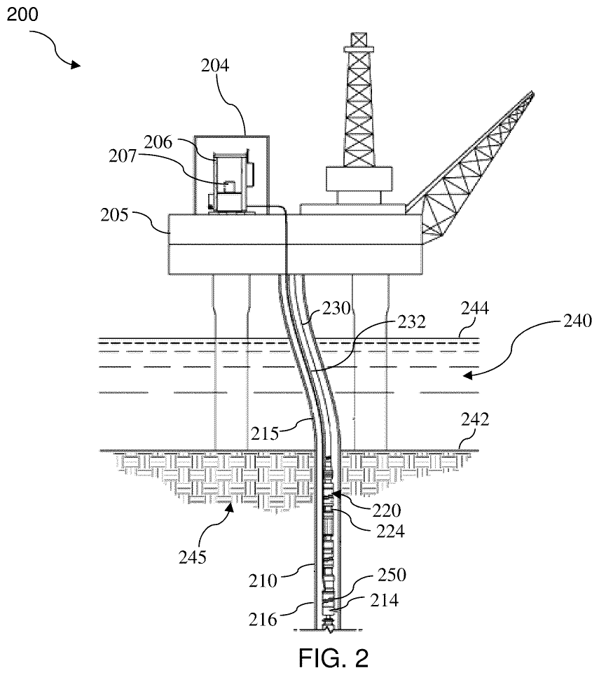

FIG. 2 is an illustration of a diagram of an example offshore well system;

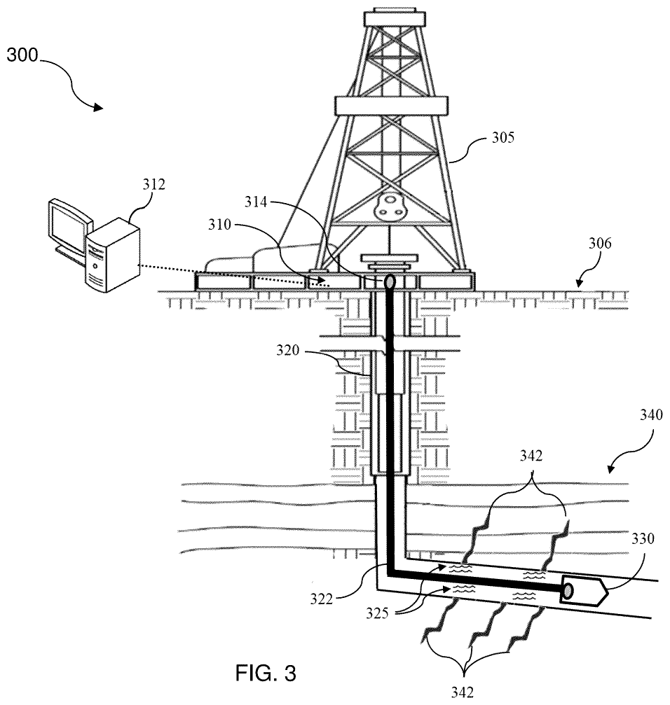

FIG. 3 is an illustration of a diagram of an example hydraulic fracturing well system;

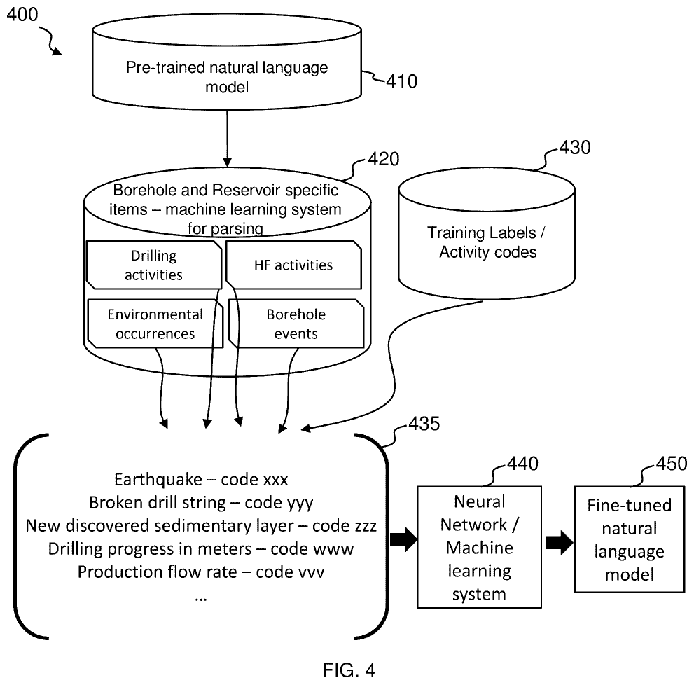

FIG. 4 is an illustration of a diagram of an example daily report training flow;

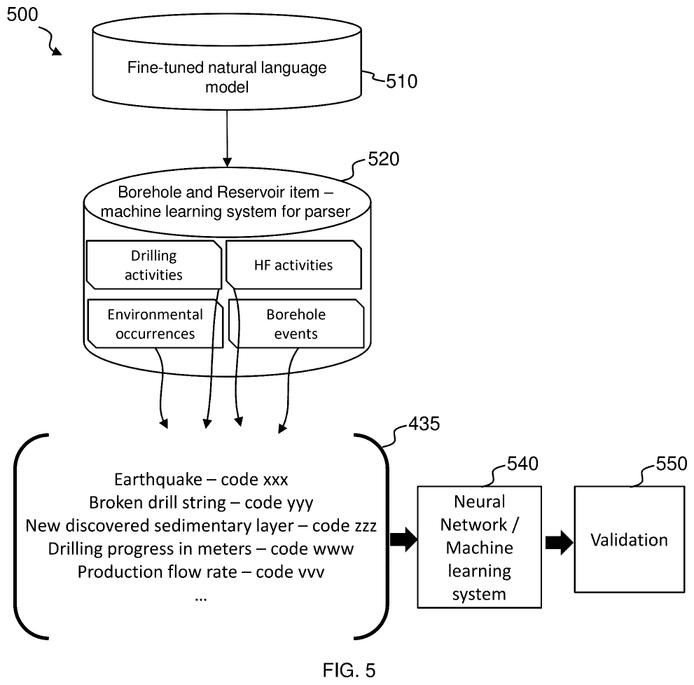

FIG. 5 is an illustration of a diagram of an example daily report classification process;

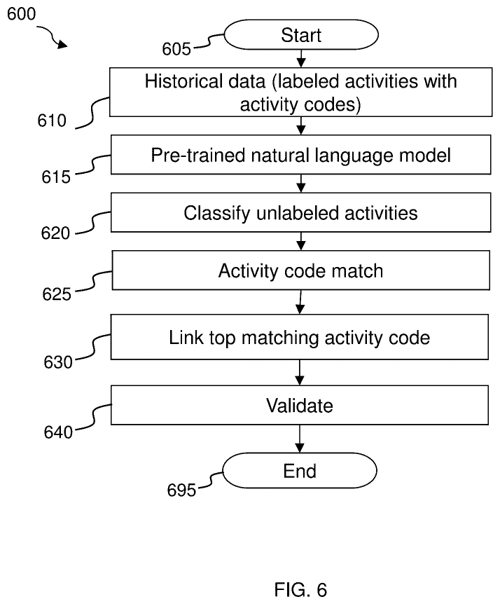

FIG. 6 is an illustration of a flow diagram of an example method to train and validate a fine-tuned natural language model;

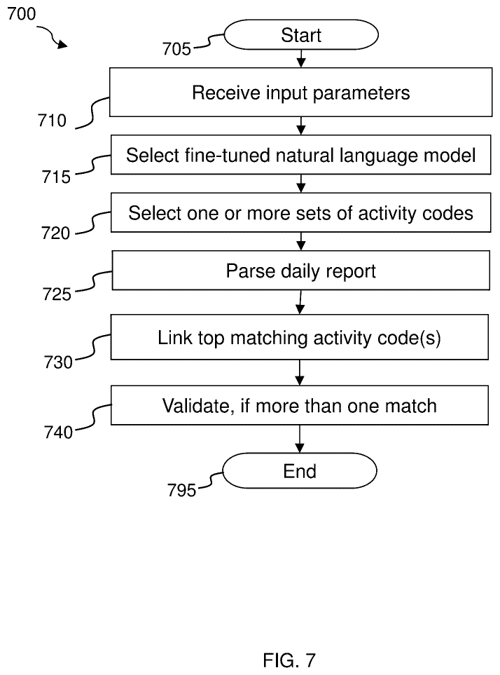

FIG. 7 is an illustration of a flow diagram of an example method utilizing a fine-tuned natural language model;

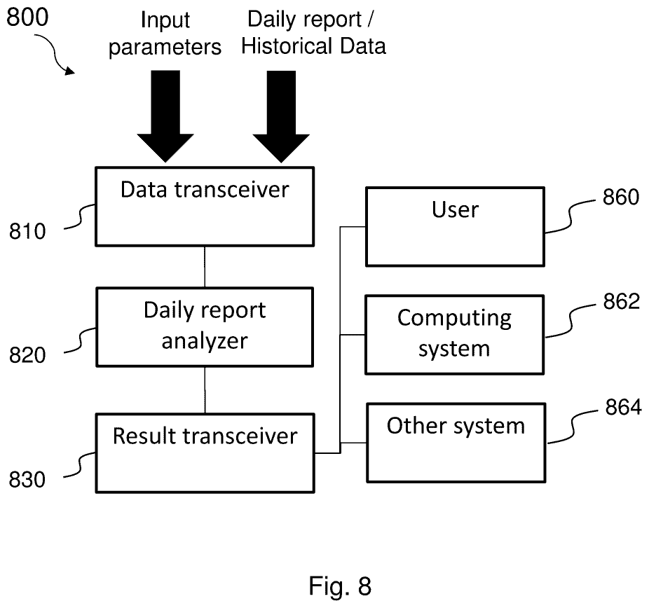

FIG. 8 is an illustration of a block diagram of an example daily report analyzer system; and

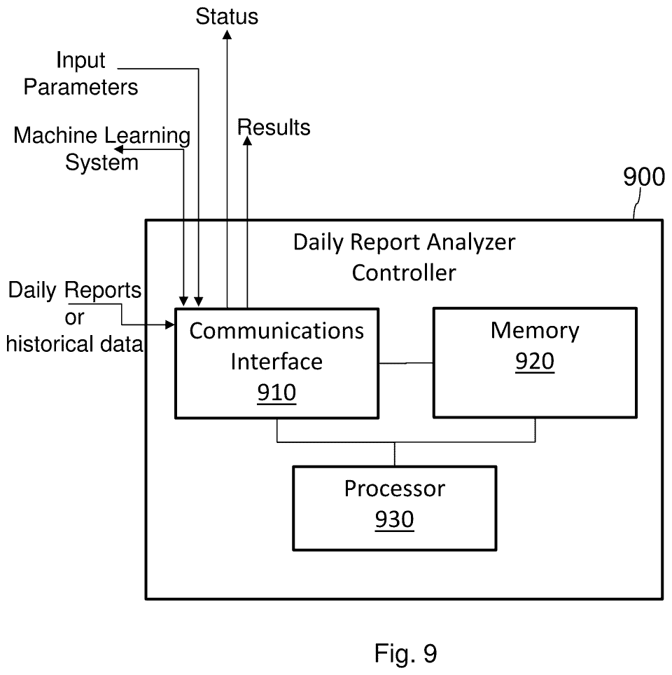

FIG. 9 is an illustration of a block diagram of an example daily report analyzer controller according to the principles of the disclosure.

### DETAILED DESCRIPTION

In developing a borehole, the engineers and operators at the borehole site can produce daily reports describing the actions taken, the results, and the difficulties encountered. The daily reports can also specify the equipment used, the composition of drilling mud or hydraulic fracturing (HF) fluid used, the type of casing employed, or other factors that occurred at the borehole site. The borehole can be for hydrocarbon production purposes, scientific purposes, or other types of borehole activities.

The borehole can be located at a location around the globe, in a country's borders, or in a body of water. The borehole can be part of a larger reservoir such as with other boreholes located within the reservoir area. The engineers and operators at the borehole location can speak or write in one or more languages. The engineers and operators can work for one of a variety of companies. One or more daily reports can be generated by the engineers or operators at the borehole. These daily reports can use a variety of forms, such as free-form answer spaces, picking a code from a list, or various combinations. Free-form text areas can contain acronyms, abbreviations, terms of art, incomplete sentences, typing errors, or other textual information that is not consistent with other daily reports from this or other boreholes. Daily reports can contain codes for the actions, occurrences, or events, some fields on the daily reports can be missing codes, or codes can be missing entirely from the daily report.

Borehole operations, such as in the oil and gas industry, are of common interest to energy corporations, government organizations, and the wider public as they can influence the financial outcomes of involved parties and the natural environment. Acquiring precise and comprehensive data on borehole operations (such as drilling operations, pumping operations, or other borehole operations) can be essential for studying borehole activities to learn from past borehole activities and optimize future borehole activities. In pursuit of this goal, oil and gas companies frequently produce daily reports for each respective borehole operation.

These daily reports encompass valuable information such as borehole status details including symptoms and events reported on-site by engineers or operators. This information can provide new insights into the borehole process and support future borehole strategies. The sheer size and volume of daily reports generated can make significant analysis of these reports impractical. The complexity and unstructured nature of daily reports adds to the difficulty of analyzing these reports.

By employing automatic classification, the data preparation process for analysis can be made more efficient, as it minimizes the need for human intervention in manually classifying borehole activities to a specific set of operator activity codes. This enables a more intelligent automated, and effective, analysis utilizing information from the daily reports.

The contents on the daily report forms can be different between countries or between companies operating at the borehole site. Even from the same borehole site, if two different companies are performing work, two different daily reports can be sent representing the activities at the borehole site, where each daily report can have a different format, be in a different language, or use different sets of codes. In some scenarios, the user preparing the daily report could use an incorrect code for an action, event, or occurrence. Actions events, and occurrences are to be interpreted to represent any action or event that affects operations of the borehole. For example, an action can be an action taken by workers at the borehole location, or workers at a remote location affecting the borehole activities, e.g., drilling x feet, pumping y gallons of HF fluid downhole, repairing casing, or other activities. An event can be a change made, e.g., mud composition change, updated subterranean formation mapping is received, or other events at the borehole or reservoir location. An event or occurrence can be a worker-initiated event or occurrence, or a naturally occurring event or occurrence, e.g., severe weather, an earthquake, floods, high winds, or other types of events or occurrences. Those actions, events, and occurrences can be time-bound, for example, between 15 minutes to 24 hours, with a typical range of one to two hours.

Typically, these daily reports, once received, can be analyzed by a user, usually in a comparative way (benchmarking or similar) or in an identification way (highlight of specific occurrences and their premises). The user can be located near the borehole location, or a distance away, such as a corporate office or offsite mobile center. This analysis could mean translating the information on the daily report to a different language, identifying proper codes to associate with the information on the daily report, classifying the information on the report, splitting the information on the daily report into different sections (such as if an operator combined information into a single free-form text field, or various combinations there. Using a unique and consistent set of codes (e.g., activity codes) for operations enables the analysis across many wells and well types. But generation of those codes for each line of operation can be a time-consuming endeavor. This work can typically take several hours to a week or more to process. For example, when client codes are available, the interpretation work can take one to two days (for example performing a “translation and cross-check” validation). When codes are not available, a week or more can be needed to interpret the daily reports for a standard set of reports (6 months' worth of operations). During this time, the drilling engineer may not be available for standard engineering and surveillance duties.

This interpretation of the daily reports by a user can have challenges. For example, the daily reports can be free-form in nature, there can be a diverse relationship between a client's activity codes and a specific set of activity codes (e.g., one-to-one, one-to-many, or many-to-one), there can be a lack of definitions for a client's activity codes, there can be an absence of a client's activity codes in the daily reports, or there can be inconsistencies in the interpretation of the borehole activities description. Each new client or the engagement of a new third-party contractor can result in a new mapping exercise before the received daily reports can be actionable.

This disclosure presents processes to address the problem of received daily reports, such as those that are not immediately actionable. The processes can reduce the time required for manually mapping the operation activities, events, or occurrences in daily reports to a specific set of operator activity codes. This can be particularly valuable for those clients who do not provide their activity code definitions or for those daily reports that do not have client activity codes associated with the written description of an activity, event, or occurrence. A second benefit is to achieve consistency in mapping operation activities across daily reports. Inconsistencies in operator's code mapping due to input code errors, varying interpretations of activity code descriptions, and varying activity code definitions by different users can be avoided.

The disclosure demonstrates training and validating a pre-trained natural language model, where the training is specific to borehole activities, events, and occurrences. The pre-trained natural language model is one that can interpret natural written language. More than one language can be pre-trained, to enable the natural language of the workers to be utilized on the daily reports. The pre-trained natural language model can be a type of model that does not use rule-based mapping techniques, such as a transformer language model.

Once the language model is trained, it can be fine-tuned to adapt to the classification task using historical labeled dataset with activity, event, or occurrence descriptions associated with a specific set of operator activity codes. The fine-tuned language model can then be used to predict the operator's activity codes for new, unlabeled activities, events, or occurrences using the descriptions. This can replace the manual interpretation by a user. The use of the fine-tuned language model can reduce the interpretation time to minutes, enabling the information to be actionable much faster than is conventionally possible.

Validation of the fine-tuned language model can be accomplished by clustering the predictions of activity codes obtained from the fine-tuned language model against each client's activity codes. This can demonstrate the relationship between each client's activity codes and a specific set of reference activity codes that can be used as a reference for validation of the code predictions.

The language model can grasp the complexity and nuances of natural language by leveraging a transformer type of architecture. The natural language model can be pre-trained on large corpora of general text data. The natural language model can enable the model to process the entire text input simultaneously and consider the full context of a word by analyzing its preceding and subsequent words in a sequence.

The existing natural language model can be fine-tuned for specific downstream natural language processing tasks including text classification. The dataset can consist of text and labels that are specific to the activities in daily reports and a specific set of activity codes can be used for fine-tuning. Fine-tuning can adapt the natural language model to the specific classification tasks while maintaining the knowledge learned during a pre-training stage. Given this fine-tuned natural language model can capture the nuances of language and classify the activities in daily reports to the specific set of activity codes, the disclosed processes can achieve improved accuracy and efficiency as compared to conventional natural language processing classification algorithms which struggle to understand the contextual relationship between words.

Daily reports can be generated for specific borehole operations containing rich information and statistics about borehole status, events, actions, occurrences, results, logging details, and other information. Some of this information can be reported in situ by engineers and operators. Daily reports can include various types and formats of data, such as free-form text, numerical values, different languages, pick lists, and other data formats. As the information is reported by human engineers or operators, there can be typing errors, incomplete sentences, non-standardized abbreviations, acronyms, terms of art, or other report entry errors. The borehole activities, which are part of the reports that mainly consist of free-form inputs, can be used for the classification task.

A pre-trained natural language model can be used as the base model. Given the language model is trained on general knowledge and a corpus of other text sources, the language model possesses knowledge about language structure semantics and context from the vast amount of text it was trained on. The pre-trained natural language model can lack an understanding of borehole operations, and oil and gas industry-specific jargon which adversely affects the accuracy of the prediction for the codes when it is used for the classification task. To address this, the natural language model can be further fine-tuned using historical data comprising the available borehole activities and their corresponding activity codes. Fine-tuning can update the parameters of the pre-trained natural language model to learn the unique textual patterns and features present in the borehole activities in conjunction with the associated activity codes. This can enable the fine-tuned language model to make more accurate predictions on new unlabeled borehole activities.

As some clients can include their own set of activity codes in the daily reports, the fine-tuned language model can predict the top matching operator's activity codes for each borehole activity on the reports from the respective client. The predictions can then be clustered against the client's activity codes to create a list of mapping between each client's code and the operator's code by identifying the top occurrence of the operator's code with the client's code. The mapping list can then be used as a reference for validation of future predictions of activity codes for the same client. This can save engineers or operators a significant amount of time when they otherwise would have to manually classify every borehole activity thereby recreating the mapping table each time.

For clients that do not provide their set of activity codes in the borehole reports, the fine-tuned language model can give the top set of matching predicted activity codes with the closest contextual meaning to each of the borehole activities in the reports. The set of matching predicted activity codes can be two or more, such as having three activity codes. These activity codes can be weighted, ranked, prioritized, or otherwise sorted in an order to help the decision-makers use the results in other decisions or validate the results and update the fine-tuned language model. This can improve the efficiency in classifying the activities for reports when a client's activity codes are not available, and can reduce human errors. In some aspects, when the fine-tuned language model is not available, the engineers or operators can classify the borehole activities line by line, taking much more time. The fine-tuned language model can be integrated into existing systems, controllers, processes, or borehole software where it can automatically classify the borehole activities on newly received daily reports.

In some aspects, an engineer or operator can generate a daily report from operations occurring at the borehole site. The daily report can be received by a daily report analyzer running on a computing system. In some aspects, the daily report analyzer can include the pre-trained natural language model. In some aspects, the daily report analyzer can communicate with the pre-trained natural language model located on a different process or system. In some aspects, the daily report analyzer can include the fine-tuned natural language model. In some aspects, the daily report analyzer can communicate with the fine-tuned natural language model located on a different process or system.

In some aspects, the daily report analyzer can be a machine learning system, a deep neural network learning system, or other types of learning systems capable of performing operations of the natural language model. In some aspects, the pre-trained natural language model and the fine-tuned natural language model can be located on the same computing system, process, borehole system, or borehole controller. In some aspects, training of the pre-trained natural language model or training of the fine-tuned natural language model can occur on the daily report analyzer, e.g., a daily report processor. In some aspects, training of the pre-trained natural language model or training of the fine-tuned natural language model can occur on a system separate from the daily report analyzer.

In some aspects, the output of the daily report analyzer can be used as an input into other machine learning systems, such as learning systems used to generate directions, e.g., instructions, for borehole operations. In some aspects, the directions can be a change in drilling direction, a change in weight-on-bit, a change in rotations per minute, or a change in drilling mud composition or HF fluid composition. In some aspects, the output of the daily report analyzer can be used as input to make decisions on future operations at the borehole, such as directing the need for different equipment, replacement equipment or supplies, or adjusting drilling operations, extraction operations, intercept operations, or other borehole operations. For example, adjusting the borehole activity can be one or more of directing the use of different equipment or ordering replacement equipment.

Turning now to the figures, FIG. 1 is an illustration of a diagram of an example drilling system 100 drilling along a planned borehole path, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105, a well site controller 107, and a computing system 108. Well site controller 107 includes a processor and a memory and is configured to direct the operation of drilling system 100. Derrick 105 is located at a surface 106.

Extending below derrick 105 is a borehole 110 with downhole tools 120 at the end of a drill string 115. Downhole tools 120 can include various downhole tools, such as a formation tester or a bottom-hole assembly (BHA). Downhole tools 120 can include a seismic tool or an ultra-deep seismic tool. At the bottom of downhole tools 120 is a drilling bit 122. Other components of downhole tools 120 can be present, such as a local power supply (e.g., generators, batteries, or capacitors), telemetry systems, sensors, transceivers, and control systems. Borehole 110 is surrounded by subterranean formation 150.

Well site controller 107 or computing system 108 which can be communicatively coupled to well site controller 107, can be utilized to communicate with downhole tools 120, such as sending and receiving acoustic data, seismic data, telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various conventional means, now known or later developed, with computing system 108 or well site controller 107. Well site controller 107 or computing system 108 can communicate with downhole tools 120 using conventional means, now known or later developed, to direct operations of downhole tools 120, e.g., geo-steering operations. Casing 130 can act as barrier between subterranean formation 150 and the fluids and material internal to borehole 110, as well as drill string 115.

In some aspects, an engineer or operator can generate a daily report from operations occurring at drilling system 100. The daily report can be received by a daily report analyzer. In some aspects, the daily report analyzer can be part of a system or controller, such as daily report analyzer system 800 of FIG. 8 or daily report analyzer controller 900 of FIG. 9. In some aspects, the daily report analyzer can be part of well site controller 107 or computing system 108. In some aspects, the daily report analyzer can be part of an edge computing system, a cloud environment, a data center environment, a corporate environment, a laboratory environment, or be implemented on a server, smartphone, laptop, or other type of computing system located proximate drilling system 100 or located a distance away.

The result output from the daily report analyzer can be used to direct operations of drilling system 100, such as to update or modify the planned borehole path, change the composition of drilling mud, prepare repairs of the casing, ensure that the proper supplies and parts are ordered, or other types of updates of drilling system 100.

FIG. 2 is an illustration of a diagram of an example offshore well system 200 with an electric submersible pump (ESP) assembly 220. ESP assembly 220 is placed downhole in a borehole 210 below a body of water 240, such as an ocean or sea. Borehole 210, protected by casing, screens, or other structures, is surrounded by subterranean formation 245. ESP assembly 220 can be used for onshore operations. ESP assembly 220 includes a well controller 207 (for example, to act as a speed and communications controller of ESP assembly 220), an ESP motor 214 (e.g., the constant speed power mechanism), and an ESP pump 224 (e.g., the fluid pump).

Well controller 207 may be placed in a cabinet 206 inside a control room 204 on an offshore platform 205, such as an oil rig, above water surface 244. Well controller 207 may be configured to adjust the operations of ESP motor 214 to improve well productivity. In the illustrated aspect, ESP motor 214 is a two-pole, three-phase squirrel cage induction motor that operates to turn ESP pump 224. ESP motor 214 is located near the bottom of ESP assembly 220, just above downhole sensors within borehole 210. An energy/communication cable 230 extends from well controller 207 to ESP motor 214. A tubular 232 fluidly couples equipment located on offshore platform 205 and ESP pump 224.

In some aspects, ESP pump 224 can be a horizontal surface pump, a progressive cavity pump, a subsurface compressor system, or an electric submersible progressive cavity pump. A motor seal section and intake section may extend between ESP motor 214 and ESP pump 224. A riser 215 separates ESP assembly 220 from water 240 until sub-surface 242 is encountered, and a casing 216 can separate borehole 210 from subterranean formation 245 at and below sub-surface 242. Perforations in casing 216 can allow the fluid of interest from subterranean formation 245 to enter borehole 210.

Located between ESP motor 214 and ESP pump 224 is a variable torque converter 250. Variable torque converter 250 can be a variable fill torque converter using a torque oil or an eddy clutch using a magnetic system. Variable torque converter 250 can be directed by a control system, such as well controller 207, to control the delivered torque from ESP motor 214 to ESP pump 224, thereby maintaining the fluid pressure at ESP pump 224 at or below a maximum threshold. A transmission can be included as well, where variable torque converter 250 can be located before or after the transmission in the torque coupling, and where variable torque converter 250 can adjust the delivered torque as gears are shifted within the transmission.

A daily report can be received by a daily report analyzer. In some aspects, the daily report analyzer can be part of well controller 207. In some aspects, the daily report analyzer can be part of a computing system located at offshore well system 200 or located a distance away. In some aspects, the output of the daily report analyzer can be used as an input into other machine learning systems. In some aspects, the output of the daily report analyzer can be used as input to make decisions on future operations at offshore well system 200, such as directing the need for different equipment, replacement equipment, or to adjust drilling operations.

FIG. 3 is an illustration of a diagram of a hydraulic fracturing (HF) well system 300, which can be a well site where HF operations are occurring through the implementation of a HF treatment stage plan. HF well system 300 demonstrates a nearly horizontal wellbore undergoing a fracturing operation.

HF well system 300 includes a surface well equipment 305 located at a surface 306, a well site control equipment 310, and a HF pump system 314 (e.g., a fluid pump system). In some aspects, well site control equipment 310 is communicatively connected to a separate computing system 312, for example, a separate server, data center, cloud service, tablet, laptop, smartphone, or other types of computing systems. Computing system 312 can be located proximate to well site control equipment 310 or located a distance from well site control equipment 310, and can be utilized by a well system engineer and operator to review the diversion model stemming from the calibration process.

Extending below surface 306 from surface well equipment 305 is a wellbore 320. Wellbore 320 can have zero or more cased sections and a bottom section that is uncased. Inserted into the wellbore 320 is a fluid pipe 322. The bottom portion of fluid pipe 322 has the capability of releasing downhole material 325, such as carrier fluid with diverter material, from fluid pipe 322 to subterranean formations 340. The release of downhole material 325 can be by perforations in fluid pipe 322, by valves placed along fluid pipe 322, or by other release means. At the end of fluid pipe 322 is a bottom hole assembly (BHA) 330, which can be one or more downhole tools or an end cap assembly.

In HF well system 300, fluid pipe 322 is releasing downhole material 325 into subterranean formation 340 at a determined HF fluid pressure and HF fluid flow rate. Downhole material 325 is being absorbed by, e.g., enter or flowing into, several fractures 342. Well site control equipment 310 can include a well site parameter collector that can collect sensor data from one or more fluid sensors proximate to the well site, located at a surface location, such as part of HF pump system 314, and located downhole within wellbore 320, such as a downhole HF fluid pressure gauge and a distributed acoustic sensor. This sensor data can be received as input parameters to well site control equipment 310.

Well site control equipment 310 and computing system 312 can direct HF pump system 314 to adjust the torque delivered to the pump to control the HF fluid pressure and the HF fluid flow rate. In some aspects, well site control equipment 310 can include a machine learning system to anticipate events that would need a change of the delivered torque using the input parameters, such as when downhole conditions change, the composition of the fluid changes, or gears in a connected transmission have been instructed to change by well site control equipment 310.

A daily report can be received by a daily report analyzer. In some aspects, the daily report analyzer can be part of well site control equipment 310. In some aspects, the daily report analyzer can be part of computing system 312, or located a distance away. In some aspects, the output of the daily report analyzer can be used as an input into other machine learning systems. In some aspects, the output of the daily report analyzer can be used as input to make decisions on future operations at HF well system 300, such as directing the need for different equipment, replacement equipment, or to adjust fracturing operations.

While FIGS. 1 and 3 depict onshore operations, those skilled in the art will understand that the disclosure is equally well suited for use in offshore operations, such as shown in FIG. 2. FIGS. 1-3 depict specific borehole configurations, and those skilled in the art will understand that the disclosure is equally well suited for use in boreholes having other orientations including vertical boreholes, horizontal boreholes, slanted boreholes, multilateral boreholes, and other borehole types. FIGS. 1-3 depict certain types of pumping operations, and those skilled in the art will understand that the disclosure can apply to drilling operations, production operations, intercept operations, relief well operations, completion operations, hydraulic fracturing operations, measure while drilling operations, logging while drilling operations, seismic while drilling operations, completed borehole operations, production testing operations, slickline or wireline operations, coiled tubing string remediation, seismic profiling, and other types of borehole operations without departing from the scope of the disclosure. For example, the disclosure can apply to a drilling borehole system, an injection borehole system, a hydraulic fracturing borehole system, a production borehole system, or a completed borehole system. The borehole operations can be to produce oil or gas products, or for scientific purposes, research, testing, or other non-hydrocarbon related purposes.

FIG. 4 is an illustration of a diagram of an example daily report training flow 400. Daily report training flow 400 can be used to train a machine learning system using one or more natural language models (such as using a separate model for different human languages). A data store 410 can receive the pre-trained natural language models. In a process 420, the received natural language models can apply a borehole or reservoir activity, event, or occurrence. For example, drilling activities that have occurred, HF activities that have occurred, environmental occurrences, or borehole events. Process 420 shows four types of activities, and there can be many more types of activities used in the training. What is shown is for demonstration purposes.

Data store 430 stores training labels that can be used. The training labels can be client activity codes, operator activity codes, or reference activity codes. The activity codes can be obtained from legacy interpretation, user operation, label fusion, client databases, user databases, or industry standard codes. The pre-trained natural language model can be used to process the borehole and reservoir specific items with the activity codes from data store 430 in a process 440. A demonstration of the matching is shown in bracket 435. The output of process 440 is a fine-tuned natural language model. Process 420, data store 430, and process 440 can be part of the same natural language model (e.g., the same machine learning system), where process 420 concentrates on parsing the daily report and process 440 concentrates on matching activity codes to the set of daily report activity elements. In a process 450, the one or more fine-tuned natural language models can be processed and stored for future utilization.

FIG. 5 is an illustration of a diagram of an example daily report validation process 500. Daily report validation process 500 builds on FIG. 4 by using the fine-tuned natural language models that were trained using daily report training flow 400. The received daily reports can be processed through machine learning models to generate appropriate activity code mappings to each appropriate element of the daily reports. In some aspects, a human language can be received as an input parameter. In some aspects, an activity code set can be indicated as an input parameter. The appropriate fine-tuned natural language model can be identified or accessed in a process 510. There can be more than one fine-tuned natural language model, for example, one for each human language that is modeled or one for each set of activity codes (e.g., one set for a client, one for the operator, or one for an industry standard reference). In some aspects, one fine-tuned natural language model can incorporate more than one language or more than one set of activity codes. Receiving a daily report in a language, such as French, would indicate that the French version of the fine-tuned natural language model should be retrieved or accessed.

In a process 520, the daily report can be parsed into appropriate elements using the fine-tuned natural language model. Parsing is most useful on the free-form text fields of the daily report. The parsing process includes matching provided activity codes to the parsed text sections. If activity codes are not present, that can be indicated as well. Process 520 can also parse out the selection or one-word fields along with activity codes, if they are present, so that the codes can be verified.

Bracket 435 demonstrating an activity to code matching is similar to what occurs in daily report training flow 400. Process 540 utilizes the fine-tuned natural language model to identify the best match or matches of the parsed elements to the activity codes, e.g., best match activity codes. In some aspects, a quantity of best match activity codes in the more than one best match activity codes does not exceed the number of matches parameter, where the matches parameter is an input parameter. Process 520 and process 540 can be part of the same natural language model (e.g., the same machine learning system), where process 520 concentrates on parsing the daily report and process 540 concentrates on matching activity codes to each daily report activity element in the set of daily report activity elements. In a process 550, the activity codes identified in the parsing process can be validated against the determined activity codes using the fine-tuned natural language model. In some aspects, a conflict can be flagged for a user to verify. In aspects where an activity code is not available or provided, a match can link an activity code to the daily report element. In aspects where there is not a match of an indicated match threshold parameter, then the top set of codes can be linked to the daily report element. The top set of codes can be two or more, such as the top three codes based on the algorithm of the fine-tuned natural language model. In these aspects, the daily report elements can be flagged for user intervention to resolve the top set of codes to the best code.

FIG. 6 is an illustration of a flow diagram of an example method 600 to train and validate a fine-tuned natural language model. Method 600 can be performed on a computing system, for example, daily report analyzer system 800 of FIG. 8 or daily report analyzer controller 900 of FIG. 9. The computing system can be a well site controller, a reservoir controller, a geo-steering system, a seismic system, a data center, a cloud environment, a server, a laptop, a corporate system, an edge computing system, a mobile device, a smartphone, a PDA, or other computing system capable of receiving the seismic data, input parameters, and capable of communicating with other computing systems. Method 600 can be encapsulated in software code or in hardware, for example, an application, code library, dynamic link library, module, function, RAM, ROM, and other software and hardware implementations. The software can be stored in a file, database, or other computing system storage mechanism. Method 600 can be partially implemented in software and partially in hardware. Method 600 can perform the steps for the described processes, for example, using a machine learning system for fine-tuning a pre-trained natural language model using borehole and reservoir-specific activities, events, and occurrences.

Method 600 starts at a step 605 and proceeds to a step 610. In step 610, historical data can be retrieved. The historical data can be daily reports with activity codes, e.g., historical daily reports. The historical data retrieved can be for a specific human language. The activity codes can be for a client, an operator, an industry reference, or a combination of sets of activity codes. Training can occur on more than one set of activity codes. Input parameters can be received, such as to specify a human language to use, specify a set or sets of activity codes to use, set a match threshold for matching daily report elements to an activity code, or other parameters.

In a step 615, a pre-trained natural language model can be selected, where the model is pre-trained on one or more human languages. In a step 620, the historical data can be parsed into an appropriate set of daily report activity elements. The set of daily report activity elements include the operational activities of a borehole or reservoir, events that have occurred at or near the borehole, and occurrences that have occurred at or near the borehole. For example, an activity can be that a certain number of feet were drilled, an event can be that the drill string broke, or an occurrence can be a hurricane passing overhead the borehole operational area. Free-form text fields can be parsed into one or more activity elements. In aspects where an activity code is associated with a daily report activity element in the set of daily report activity elements, that activity code is linked with the activity element.

In a step 620, for daily report activity elements that do not have an associated activity code, the activity elements can be classified by one or more various categories, factors, or attributes. In a step 625, the categories, factors, or attributes can be used to match an activity code (or codes if more than one applies, or more than one set of activity codes is being trained). In a step 630, the activity code or activity codes can be linked to the daily report activity element. If there is a match that satisfies the match threshold, then a single activity code link can be made. If the match threshold is not satisfied, then two or more activity codes can be linked to the activity element.

In a step 640, the activity code matches to each of the daily report activity elements can be validated. The activity codes can be corrected if needed. If there is more than one activity code, from the same set of activity codes, linked to an activity element, a user can select the best matching activity code. The results from step 640 can be used to update the pre-trained natural language model to be a fine-tuned natural language model that includes at least one set of activity codes associated with various daily report activity elements. Method 600 ends at a step 695.

FIG. 7 is an illustration of a flow diagram of an example method 700 to utilize a fine-tuned natural language model. Method 700 can be performed on a computing system, for example, daily report analyzer system 800 of FIG. 8 or daily report analyzer controller 900 of FIG. 9. The computing system can be a well site controller, a reservoir controller, a geo-steering system, a seismic system, a data center, a cloud environment, a server, a laptop, a corporate system, an edge computing system, a mobile device, a smartphone, a PDA, or other computing system capable of receiving the seismic data, input parameters, and capable of communicating with other computing systems. Method 700 can be encapsulated in software code or in hardware, for example, an application, code library, dynamic link library, module, function, RAM, ROM, and other software and hardware implementations. The software can be stored in a file, database, or other computing system storage mechanism. Method 700 can be partially implemented in software and partially in hardware. Method 700 can perform the steps for the described processes, for example, using a machine learning system for determining one or more activity codes for each daily report activity element.

Method 700 starts at a step 705 and proceeds to a step 710. In step 710, input parameters can be received. The input parameters can be one or more of a human, one or more activity codes or activity code parameters, a match threshold, or other input parameters. A human language parameter can specify which fine-tuned natural language model to utilize if the models are trained on specific languages, abbreviations, idioms, and nuances thereof. The set of activity codes can be a set for a client, a set for an operator, a set for a specific company, a set for industry references (such as a standard), or combinations thereof. The match threshold can be used by the fine-tuned natural language model to determine whether a match to an activity code has been made or if the top best matches are linked to the activity element. There can be two or more best matches. The number of best matches can be an input parameter.

In a step 715, a fine-tuned natural language model can be selected using the input parameters. In a step 720, one or more sets of activity codes can be selected for use in matching. In a step 725, the received daily report can be parsed into daily report activity elements by the fine-tuned natural language model. This typically occurs with free-form text fields. Single entry fields or selection fields are also parsed into activity elements, as they may or may not have associated activity codes. Activity codes, e.g., original activity codes, specified in the daily report are associated with each activity element that is parsed.

In a step 730, the fine-tuned natural language model can be used to identify the best matches to the activity elements. If a match exceeds the match threshold, then the top match is linked with the activity element. If no match exceeds the match threshold, then the top best matches are linked with the activity element.

In a step 740, if a daily report activity element does not have an activity code from the parsing of the daily report and has one top match from the fine-tuned natural language model, then that linked activity code is used for that activity element in the results. If a daily report activity element does have an activity code from the parsing of the daily report and has one top match from the fine-tuned natural language model and those two activity codes match, then that linked activity code is used for that activity element in the results. If there is more than one activity code, such as when the parsed activity code does not match the activity code determined by the fine-tuned natural language model or the fine-tuned natural language model determines more than one activity code (from the same set of activity codes) than a validation of the activity code is performed. For example, a user can review the daily report and select the correct or best matching activity code. The corrected activity element and linked activity code can then be part of the results. This process can be repeated for each set of activity codes that were selected to be used.

The results for each daily report activity code can be grouped together to generate a standardized daily report containing all of the activity elements with their linked activity codes (where there can be more than one activity code in aspects where more than one activity code set as selected). Method 700 ends at a step 795.

FIG. 8 is an illustration of a block diagram of an example daily report analyzer system 800. which can be implemented in one or more computing systems, for example, a data center, a cloud environment, a server, a laptop, a smartphone, a tablet, an edge computing system, a laboratory system, or other computing systems. In some aspects, daily report analyzer system 800 can be implemented using a daily report analyzer controller such as daily report analyzer controller 900 of FIG. 9. Daily report analyzer system 800 can implement one or more methods of this disclosure, such as method 600 of FIG. 6 or method 700 of FIG. 7.

Daily report analyzer system 800, or a portion thereof, can be implemented as an application, a code library, a dynamic link library, a function, a module, other software implementation, or combinations thereof. In some aspects, daily report analyzer system 800 can be implemented in hardware, such as a ROM, a graphics processing unit, or other hardware implementation. In some aspects, daily report analyzer system 800 can be implemented partially as a software application and partially as a hardware implementation. Daily report analyzer system 800 is a functional view of the disclosed processes and an implementation can combine or separate the described functions in one or more software or hardware systems.

Daily report analyzer system 800 includes a data transceiver 810, a daily report analyzer 820, and a result transceiver 830. The standardized daily report and interim outputs from daily report analyzer 820 can be communicated to a data receiver, such as one or more of a user or user system 860, a computing system 862, or other processing or storage systems 864. The standard daily report can be used to determine changes to a borehole operation, a reservoir operation, when replacement parts are ordered or shipped, if emergency actions need to be implemented, or to adjust progress guidance on development of the borehole or reservoir.

Data transceiver 810 can receive input parameters, such as parameters to direct the operation of the analysis implemented by daily report analyzer 820, such as a fine-tuned natural language model parameter, a set of activity codes parameter, a matching threshold parameter, or a number of matches parameter. In some aspects, data transceiver 810 can be part of daily report analyzer 820.

Result transceiver 830 can communicate one or more results (standardized daily report or an updated fine-tuned natural language model), analysis, or interim outputs, to one or more data receivers, such as user or user system 860, computing system 862, storage system 864, e.g., a data store or database, or other related systems, whether located proximate result transceiver 830 or distant from result transceiver 830. Data transceiver 810, daily report analyzer 820, and result transceiver 830 can be, or can include, conventional interfaces configured for transmitting and receiving data. In some aspects, daily report analyzer 820 can be a machine learning system or a deep neural network learning system, such as providing a process to parse and analyze a received daily report and match activity codes to the parsed daily report activity elements.

Daily report analyzer 820, such as a daily report processor, can implement the analysis and algorithms as described herein utilizing the daily report and the input parameters. For example, daily report analyzer 820 can perform the parsing of the received daily report, match one or more activity codes to the daily report activity elements, validate the matches, link the matched activity codes to the daily report activity elements, and communicate the standardized daily report.

A memory or data storage of daily report analyzer 820 can be configured to store the processes and algorithms for directing the operation of daily report analyzer 820. Daily report analyzer 820 can also include a processor that is configured to operate according to the analysis operations and algorithms disclosed herein, and an interface to communicate (transmit and receive) data.

FIG. 9 is an illustration of a block diagram of an example daily report analyzer controller 900 according to the principles of the disclosure. Daily report analyzer controller 900 can be stored on a single computer or on multiple computers. The various components of daily report analyzer controller 900 can communicate via wireless or wired conventional connections. A portion or a whole of daily report analyzer controller 900 can be located at one or more locations and other portions of daily report analyzer controller 900 can be located on a computing device or devices located at a surface location. In some aspects, daily report analyzer controller 900 can be wholly located at a surface or distant location. In some aspects, daily report analyzer controller 900 can be part of another system, and can be integrated in a single device, such as a part of a borehole operation planning system, a reservoir controller, a corporate system, a data center, a cloud environment, an edge computing system, a well site controller, a geo-steering system, or other borehole system.

Daily report analyzer controller 900 can be configured to perform the various functions disclosed herein including receiving input parameters and daily reports, and generating the standardized daily reports from an execution of the methods and processes described herein, such as parsing the received daily reports and matching activity codes to the daily report activity elements. Daily report analyzer controller 900 includes a communications interface 910, a memory 920, and a processor 930.

Communications interface 910 is configured to transmit and receive data. For example, communications interface 910 can receive the input parameters and daily reports. Communications interface 910 can transmit the standardized daily report or interim outputs. In some aspects, communications interface 910 can transmit a status, such as a success or failure indicator of daily report analyzer controller 900 regarding receiving the various inputs, transmitting the generated feature results, or producing the standardized daily report.

In some aspects, a machine learning system can be implemented by processor 930 and perform the operations as described by daily report analyzer 820. Communications interface 910 can communicate via communication systems used in the industry. For example, wireless or wired protocols can be used. Communication interface 910 is capable of performing the operations as described for data transceiver 810 and result transceiver 830 of FIG. 8.

Memory 920 can be configured to store a series of operating instructions that direct the operation of processor 930 when initiated, including the code representing the algorithms for determining processing the collected data. Memory 920 is a non-transitory computer readable medium. Multiple types of memory can be used for data storage and memory 920 can be distributed.

Processor 930, such as a daily report processor, can be configured to produce the standardized daily report, one or more interim outputs, and statuses utilizing the received inputs. For example, processor 930 can analyze the received daily report, parse it into daily report activity elements, and match activity codes to each daily report activity element. Processor 930 can be configured to direct the operation of daily report analyzer controller 900. Processor 930 includes the logic to communicate with communications interface 910 and memory 920, and perform the functions described herein. Processor 930 is capable of performing or directing the operations as described by feature analyzer 820 of FIG. 8.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Aspects disclosed herein include:

A. A method, comprising (1) receiving historical daily reports from a data store, wherein the historical daily reports have been validated with at least one set of activity codes, (2) selecting a pre-trained natural language model that is pre-trained on natural language processing, where the pre-trained natural language model is a transformer language model, (3) selecting a set of activity codes, where activity codes in the set of activity codes represent activities, events, or occurrences at a borehole location or a reservoir location, and (4) generating a fine-tuned natural language model by training the pre-trained natural language model using borehole or reservoir activities, events, or occurrences, wherein the training includes (4a) parsing the historical daily reports into a set of daily report activity elements, (4b) matching each daily report activity element in the set of daily report activity elements with at least one activity code in the set of activity codes, (4c) validating the at least one activity code when there at least two activity codes by selecting a best match activity code, and (4d) linking to each daily report activity element in the set of daily report activity elements, the best match activity code or the at least one activity code.
B. A method, comprising (1) receiving a daily report from an engineer or an operator, wherein the daily report describes activities, events, or occurrences at a reservoir location or a borehole location, and the daily report uses free-form text fields where at least one field specifies an incorrect activity code or is missing an activity code, (2) receiving input parameters, wherein the input parameters include one or more of a human language parameter, an activity code parameter, a match threshold parameter, or a number of matches parameter, (3) selecting a fine-tuned natural language model that has undergone fine-tuned training, wherein the fine-tuned language model is selected using a default parameter or the human language parameter, (4) parsing the daily report into a set of daily report activity elements, wherein each daily report activity element in the set of daily report activity elements includes an original activity code when available from the daily report, (5) matching each daily report activity element in the set of daily report activity codes with at least one best match activity code from a set of activity codes, forming linked activity codes for the each daily report activity element, wherein the set of activity codes is specified by the activity code parameter, (6) generating a standardized daily report using the each daily report activity element and the respective linked activity codes, and (7) adjusting a borehole activity at the borehole location or a reservoir activity at the reservoir location using the standardized daily report.
C. A system, comprising (1) a data transceiver, capable of receiving input parameters and a daily report having free-form text fields, wherein the daily report describes activities, events, or occurrences at a reservoir location or a borehole location, where at least one free-form text field uses an incorrect activity code or is missing an activity code, and the input parameters include one or more of a human language parameter, (2) a fine-tuned natural language model, capable of parsing the daily report into a set of daily report activity elements and, when available, associated original activity codes, wherein the fine-tuned language model is selected using a default parameter or the human language parameter, and (3) a daily report processor, capable of linking one or more activity codes to each daily report activity element in the set of daily report activity elements, validating one or more activity codes when more than one activity code is linked or the original activity codes is available, generating a standardized daily report using the each daily report activity element and respective linked one or more activity codes, and adjusting a borehole activity at the borehole location or a reservoir activity at the reservoir location using the standardized daily report, wherein the standardized daily report has a more accurate match between the set of daily report activity elements and the one or more activity codes than the daily report.
D. A computer program product having a series of operating instructions stored on a non-transitory computer-readable medium that directs a natural language model to perform parsing and matching operations, the operations comprising (1) receiving a daily report from an engineer or an operator, wherein the daily report describes activities, events, or occurrences at a reservoir location or a borehole location, and the daily report uses free-form text fields where at least one field specifies an incorrect activity code or is missing an activity code, (2) receiving input parameters, wherein the input parameters include one or more of a human language parameter, an activity code parameter, a match threshold parameter, or a number of matches parameter, (3) selecting a fine-tuned natural language model that has undergone fine-tuned training, wherein the fine-tuned language model is selected using a default parameter or the human language parameter, (4) parsing the daily report into a set of daily report activity elements, wherein each daily report activity element in the set of daily report activity elements includes an original activity code when available from the daily report, (5) matching each daily report activity element in the set of daily report activity elements with at least one best match activity code from a set of activity codes, forming linked activity codes for each daily report activity element, wherein the set of activity codes is specified by the activity code parameter, (6) generating a standardized daily report using the set of daily report activity elements and the respective linked activity codes, and (7) adjusting a borehole activity at the borehole location or a reservoir activity at the reservoir location using the standardized daily report, wherein the standardized daily report has a more accurate match between the daily report activity elements and the at least one best match activity codes than the received daily report.

Each of the disclosed aspects in A, B, C, and D can have one or more of the following additional elements in combination. Element 1: further comprising adjusting steering of drill bit via a geo-steering system of a downhole borehole tool using the fine-tuned natural language model. Element 2: wherein an output of the fine-tuned natural language model is used to generate directions for the geo-steering system. Element 3: wherein the pre-trained natural language model is trained using more than one human language. Element 4: further comprising verifying the fine-tuned natural language model through clustering the at least one activity code or the best match activity code with a client or an operator set of activity codes to generate a list mapping between a matching set of activity codes and the client or the operator set of activity codes. Element 5: wherein the list mapping is used as a reference for validation of future executions of the method when the same client or operator is selected. Element 6: wherein the set of activity codes is more than one set of activity codes, where each set of activity codes is for a different one of client codes, operator codes, reference codes, or industry codes. Element 7: wherein the set of activity codes is more than one set of activity codes, where each set of activity codes in the more than one set of activity codes is for a different client. Element 8: wherein the adjusting the borehole activity is one of directing a need for different equipment or replacement equipment. Element 9: wherein the adjusting the borehole activity is one of updating a planned borehole path, changing composition of drilling mud, or preparing repairs of a casing. Element 10: wherein the adjusting the borehole activity directs operations of downhole tools or geo-steering operations. Element 11: wherein the set of activity codes are client codes or operator codes. Element 12: wherein the set of activity codes are industry codes or reference codes. Element 13: wherein the matching further comprises validating one best match activity code from the at least one best match activity code when the original activity code matches a selected activity code from the at least one best match activity code, or when the original activity code is not provided or the original activity code does not match the activity code from the at least one best match activity code and the activity code satisfies the match threshold parameter. Element 14: wherein the matching further comprises validating more than one best match activity codes from the at least one best match activity code when no best match activity code in the at least one best match activity code satisfies the match threshold parameter and the more than one best match activity codes are top matches as determined by the fine-tuned natural language model, wherein a quantity of best match activity codes in the more than one best match activity codes does not exceed the number of matches parameter. Element 15: wherein the validating further comprises determining one best match activity code from the more than one best match activity codes by a user review. Element 16: wherein the parsing the daily report parses the free-form text fields of the daily report. Element 17: wherein the adjusting the borehole activity is one or more of modifying a planned borehole path, instructing a change to a geo-steering system, changing a composition of drilling mud, or preparing repairs of casing. Element 18: wherein the adjusting the borehole activity is one or more of directing the use of different equipment or ordering replacement equipment. Element 19: further comprising a daily report analyzer system, capable of including the fine-tuned natural language model and the daily report processor. Element 20: wherein the fine-tuned natural language model and the daily report processor are a machine learning system or a deep neural network learning system. Element 21: wherein the system is located proximate the borehole location or the reservoir location. Element 22: further comprising a result transceiver, capable of communicating the standardized daily report to a user system, a data store, a computing system, a borehole system, or a reservoir system. Element 23: wherein the matching further comprises validating more than one best match activity codes from the at least one best match activity code when no best match activity code in the at least one best match activity code satisfies the match threshold parameter and the more than one best match activity codes are top matches as determined by the fine-tuned natural language model. Element 24: wherein a quantity of best match activity codes in the more than one best match activity codes does not exceed the number of matches parameter.

What is claimed is:

1. A method, comprising:
receiving historical daily reports from a data store, wherein the historical daily reports have been validated with at least one set of activity codes;
selecting a pre-trained natural language model that is pre-trained on natural language processing, where the pre-trained natural language model is a transformer language model;
selecting a set of activity codes, where activity codes in the set of activity codes represent activities, events, or occurrences at a borehole location or a reservoir location; and
generating a fine-tuned natural language model by training the pre-trained natural language model using borehole or reservoir activities, events, or occurrences, wherein the training includes:
parsing the historical daily reports into a set of daily report activity elements;
matching each daily report activity element in the set of daily report activity elements with at least one activity code in the set of activity codes;
validating the at least one activity code when there at least two activity codes by selecting a best match activity code; and
linking to each daily report activity element in the set of daily report activity elements, the best match activity code or the at least one activity code.

2. The method as recited in claim 1, further comprising:
adjusting steering of drill bit via a geo-steering system of a downhole borehole tool using the fine-tuned natural language model, wherein an output of the fine-tuned natural language model is used to generate directions for the geo-steering system.

3. The method as recited in claim 1, wherein the pre-trained natural language model is trained using more than one human language.

4. The method as recited in claim 1, further comprising:
verifying the fine-tuned natural language model through clustering the at least one activity code or the best match activity code with a client or an operator set of activity codes to generate a list mapping between a matching set of activity codes and the client or the operator set of activity codes.

5. The method as recited in claim 4, wherein the list mapping is used as a reference for validation of future executions of the method when the same client or operator is selected.

6. The method as recited in claim 1, wherein the set of activity codes is more than one set of activity codes, where each set of activity codes is for a different one of client codes, operator codes, reference codes, or industry codes.

7. The method as recited in claim 1, wherein the set of activity codes is more than one set of activity codes, where each set of activity codes in the more than one set of activity codes is for a different client.

8. A method, comprising:
receiving a daily report from an engineer or an operator, wherein the daily report describes activities, events, or occurrences at a reservoir location or a borehole location, and the daily report uses free-form text fields where at least one field specifies an incorrect activity code or is missing an activity code;
receiving input parameters, wherein the input parameters include one or more of a human language parameter, an activity code parameter, a match threshold parameter, or a number of matches parameter;
selecting a fine-tuned natural language model that has undergone fine-tuned training, wherein the fine-tuned language model is selected using a default parameter or the human language parameter;
parsing the daily report into a set of daily report activity elements, wherein each daily report activity element in the set of daily report activity elements includes an original activity code when available from the daily report;
matching each daily report activity element in the set of daily report activity codes with at least one best match activity code from a set of activity codes, forming linked activity codes for the each daily report activity element, wherein the set of activity codes is specified by the activity code parameter;
generating a standardized daily report using the each daily report activity element and the respective linked activity codes; and
adjusting a borehole activity at the borehole location or a reservoir activity at the reservoir location using the standardized daily report.

9. The method as recited in claim 8, wherein the adjusting the borehole activity is one of directing a need for different equipment or replacement equipment.

10. The method as recited in claim 8, wherein the adjusting the borehole activity is one of updating a planned borehole path, changing composition of drilling mud, or preparing repairs of a casing.

11. The method as recited in claim 8, wherein the adjusting the borehole activity directs operations of downhole tools or geo-steering operations.

12. The method as recited in claim 8, wherein the set of activity codes are client codes or operator codes.

13. The method as recited in claim 8, wherein the set of activity codes are industry codes or reference codes.

14. The method as recited in claim 8, wherein the matching further comprises:
validating one best match activity code from the at least one best match activity code when the original activity code matches a selected activity code from the at least one best match activity code, or when the original activity code is not provided or the original activity code does not match the activity code from the at least one best match activity code and the activity code satisfies the match threshold parameter.

15. The method as recited in claim 8, wherein the matching further comprises:
validating more than one best match activity codes from the at least one best match activity code when no best match activity code in the at least one best match activity code satisfies the match threshold parameter and the more than one best match activity codes are top matches as determined by the fine-tuned natural language model, wherein a quantity of best match activity codes in the more than one best match activity codes does not exceed the number of matches parameter.

16. The method as recited in claim 15, wherein the validating further comprises:
determining one best match activity code from the more than one best match activity codes by a user review.

17. The method as recited in claim 8, wherein the parsing the daily report parses the free-form text fields of the daily report.

18. A system, comprising:
a data transceiver, capable of receiving input parameters and a daily report having free-form text fields, wherein the daily report describes activities, events, or occurrences at a reservoir location or a borehole location, where at least one free-form text field uses an incorrect activity code or is missing an activity code, and the input parameters include one or more of a human language parameter;
a fine-tuned natural language model, capable of parsing the daily report into a set of daily report activity elements and, when available, associated original activity codes, wherein the fine-tuned language model is selected using a default parameter or the human language parameter; and
a daily report processor, capable of linking one or more activity codes to each daily report activity element in the set of daily report activity elements, validating one or more activity codes when more than one activity code is linked or the original activity codes is available, generating a standardized daily report using the each daily report activity element and respective linked one or more activity codes, and adjusting a borehole activity at the borehole location or a reservoir activity at the reservoir location using the standardized daily report, wherein the standardized daily report has a more accurate match between the set of daily report activity elements and the one or more activity codes than the daily report.

19. The system as recited in claim 18, wherein the adjusting the borehole activity is one or more of modifying a planned borehole path, instructing a change to a geo-steering system, changing a composition of drilling mud, or preparing repairs of casing.

20. The system as recited in claim 18, wherein the adjusting the borehole activity is one or more of directing the use of different equipment or ordering replacement equipment.

21. The system as recited in claim 18, further comprising:
a daily report analyzer system, capable of including the fine-tuned natural language model and the daily report processor.

22. The system as recited in claim 18, wherein the fine-tuned natural language model and the daily report processor are a machine learning system or a deep neural network learning system.

23. The system as recited in claim 18, wherein the system is located proximate the borehole location or the reservoir location.

24. The system as recited in claim 18, further comprising:
a result transceiver, capable of communicating the standardized daily report to a user system, a data store, a computing system, a borehole system, or a reservoir system.

25. A computer program product having a series of operating instructions stored on a non-transitory computer-readable medium that directs a natural language model to perform parsing and matching operations, the operations comprising:
receiving a daily report from an engineer or an operator, wherein the daily report describes activities, events, or occurrences at a reservoir location or a borehole location, and the daily report uses free-form text fields where at least one field specifies an incorrect activity code or is missing an activity code;
receiving input parameters, wherein the input parameters include one or more of a human language parameter, an activity code parameter, a match threshold parameter, or a number of matches parameter;
selecting a fine-tuned natural language model that has undergone fine-tuned training, wherein the fine-tuned language model is selected using a default parameter or the human language parameter;
parsing the daily report into a set of daily report activity elements, wherein each daily report activity element in the set of daily report activity elements includes an original activity code when available from the daily report;
matching each daily report activity element in the set of daily report activity elements with at least one best match activity code from a set of activity codes, forming linked activity codes for each daily report activity element, wherein the set of activity codes is specified by the activity code parameter;
generating a standardized daily report using the set of daily report activity elements and the respective linked activity codes; and
adjusting a borehole activity at the borehole location or a reservoir activity at the reservoir location using the standardized daily report, wherein the standardized daily report has a more accurate match between the daily report activity elements and the at least one best match activity codes than the received daily report.

26. The computer program product as recited in claim 25, wherein the matching further comprises:
validating more than one best match activity codes from the at least one best match activity code when no best match activity code in the at least one best match activity code satisfies the match threshold parameter and the more than one best match activity codes are top matches as determined by the fine-tuned natural language model, wherein a quantity of best match activity codes in the more than one best match activity codes does not exceed the number of matches parameter.
